(19) United States
(12) Patent Application Publication
(10) Pub. No.: US 2026/0337726 A1
(43) Pub. Date: Oct. 29, 2026

(54) Process for Separation and Purification of Heavy Rare Earth Elements by Liquid/Liquid Extraction

(71) Applicant: Rhodia Operations, Lyon (FR)

(72) Inventors: Alain Rollat, Paris (FR); Clémence Berger, Paris (FR)

(21) Appl. No.: 19/481,215

(22) PCT Filed: Apr. 9, 2024
(86) PCT No.: PCT/FR2024/050461

§ 371 Date: Nov. 4, 2025

(30) Foreign Application Priority Data
May 5, 2023 (FR) FR2304516

(51) Int. Cl. C22B 59/00; C22B 3/28; C22B 3/38

(52) U.S. Cl. CPC C22B 59/00; C22B 3/288; C22B 3/3842; C22B 3/3844

(57) ABSTRACT

Provided herein is a process for the production of a terbium-dysprosium mixture or of dysprosium from a mixture of rare earth elements in solution, said process including at least two consecutive steps of separation by liquid-liquid extraction, conducted with the use of two different solvents, S1 and S2:
the first separation step being conducted using solvent S1, which includes at least one anionic extraction agent,
the second separation step being conducted using solvent S2, which includes at least one cationic extraction agent.

### CROSS-REFERENCE TO RELATED APPLICATIONS

This application is the United States national phase of International Patent Application No. PCT/FR2024/050461 filed Apr. 9, 2024, and claims priority to French Patent Application No. FR2304516 filed May 5, 2023, the disclosures of which are hereby incorporated by reference in their entireties.

### BACKGROUND OF THE INVENTION

### Field of the Invention

The invention relates to the field of the separation of rare earth elements, and in particular of heavy rare earth elements (HREEs).

Rare earth elements are a group of metals having similar chemical properties, comprising fourteen stable elements from the lanthanide family, lanthanum (La), cerium (Ce), praseodymium (Pr), neodymium (Nd), samarium (Sm), europium (Eu), gadolinium (Gd), terbium (Tb), dysprosium (Dy), holmium (Ho), erbium (Er), thulium (Tm), ytterbium (Yb) and lutetium (Lu), as well as scandium (Sc) and yttrium (Y), which are transition metals.

Specifically, rare earth elements having the highest atomic numbers are qualified as “heavy rare earth elements.” Associated with these is yttrium, which although it has a lower atomic number, exhibits chemical properties close to erbium.

Their specific physical properties, in particular their magnetic properties, have led to their use in numerous industries, in particular in renewable energies, such as wind turbines and electric vehicles.

The expression “rare earth elements” used according to the invention describes heavy rare earth elements.

Rare earth elements are generally extracted from ores such as monazite, xenotime, in which they are present in the form of phosphates, bastnaesite, in which they are present in the form of fluorocarbonates, or in certain clays, in which they are present in ionic forms.

Traditionally, their extraction starts through the processing of the ores, which, after multiple hydrometallurgical operation steps, leads to aqueous solutions of nitrates or chlorides of rare earth element mixtures. These elements then need to be isolated in order to ultimately bring out their value.

Therefore, the invention relates to a separation process for the rare earth elements contained in an acid solution comprising the rare earth elements Sm, Eu, Gd, Tb, Dy, Ho, Er, Tm, Yb, Lu and Y.

### Description of Related Art

The separation of rare earth elements from each other is complex, since these elements have similar chemical properties, making them difficult to isolate.

The processes most used implement at least one liquid-liquid extraction, with the help of at least one solvent. Conventionally, the most effective methods depend on the selectivity of this extraction solvent, of an organic nature, vis-a-vis the rare earth elements, and choosing them depends on the rare earth that one wishes to isolate. Selectivity means the ability to separate two elements.

In the specific case of heavy rare earth elements, the type of solvent used depends on the acid used during the dissolution of the concentrate of rare earth elements obtained after the processing of the ores. In this way, in the case of hydrochloric solutions, only organophosphorus acid type molecules exhibit a selectivity sufficient for separating the heavy rare earth elements from each other. For nitric solutions, the molecules used are organophosphorus acids and amines, and in particular quaternary ammonium salts.

Organophosphorus acids match the following formulas:

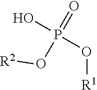

phosphoric acid ester

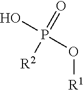

phosphonic acid ester

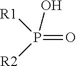

phosphonic acid
where R1 and R2 are chosen independently from the group comprising alkyl or aryl radicals, linear or branched aromatics.

In particular, document EP 0156735 describes a process for separating lanthanides and yttrium by a liquid-liquid extraction, implementing an extraction solvent comprising a phosphonic acid, such as di-n-octylphosphonic acid or bis(ethyl-2 hexyl) phosphonic acid.

Organophosphorus acids, in addition to being very selective, lead to the consumption of large quantities of acids and bases in the separation process, due to the driving force of the liquid-liquid equilibrium, which is tied to the energy needed to achieve the liquid-liquid equilibrium, and which depends on the acidity of the aqueous medium, according to the following reaction:

TR³⁺_{aq}+3HL_{org}⇄TRL_{3, org}+3H⁺_{aq}

where TR represents a rare earth element, HL represents the organophosphorus acid and L is the base that is associated with it.

The extraction of the rare earth elements needs to move the equilibrium to the right by neutralizing the acidity of the aqueous medium by adding a base. The aqueous phase is then acidified by adding an acid, the equilibrium is moved to the left, and the rare earth element is then in a aqueous solution in the form of a trivalent ion. In this way the solvent is regenerated.

However, each addition of an acid (HCl or HNO₃), or of a base (NaOH or NH₄OH) creates saline effluents (NaCl or NH₄NO₃), generally released into the environment.

The amount of base and acid necessary increases as a function of the atomic number of the rare earth element. This becomes particularly significant for the heaviest elements (Ho, Er, Tm, Yb and Lu) and for yttrium. In particular, mixtures coming from ionic clay-type ores and xenotime are rich in heavy rare earth elements, and their separation therefore requires an increased quantity of acids and bases.

For example, document FR 2460275 describes a process for separating rare earth elements implementing an extraction solvent comprising a phosphonic acid, the mono-2-ethylhexyl ester of 2-ethylhexylphosphonic acid. However, this process uses a large amount of acid.

Another category of extraction solvents is known for its selectivity vis-a-vis heavy rare earth elements in a nitrate medium, in particular for the heaviest elements (Ho, Er, Tm, Tb and Lu) and for yttrium. These are quaternary ammonium-based extraction solvents, which match the following formula:

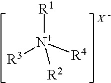

where R1, R2, R3 and R4 are chosen independently from the group comprising the alkyls of more than 4 carbon atoms.

The document U.S. Pat. No. 3,640,678 in particular describes a process for purification of yttrium from a solution of heavy rare earth elements, using the quaternary ammonium nitrated sold under the name of Aliquat™ 336. These Aliquat 336, or even Adogen 464 HF, extractants are quaternary ammoniums of the formula tri-C8-C10 alkylmethyl ammonium, sold in the form of chlorides. They are transformed into nitrates to be advantageously used in separating rare earth elements.

These molecules do not require additional consumption of acids and bases when implementing the process since the driving force of the liquid-liquid equilibrium is not tied to the acidity of the aqueous phase, but only to the nitrate concentration, according to the following reaction:

$${TR}_{aq}^{3 +} + 3 {NO}_{3 aq}^{-} + {( {R}_{3} {CH}_{3} {N}^{+} , {NO}_{3}^{-} )}_{org} ⇄ {[ {R}_{3} {CH}_{3} {N}^{+} , {TR ( {NO}_{3} )}_{4}^{-} ]}_{org}$$

where TR represents a rare earth element, and R₃CH₃N⁺ represents a quaternary ammonium.

The extraction of the rare earth element recovered in an aqueous phase needs to move the equilibrium to the right by augmenting the concentration of the nitrate aqueous phase, by evaporation of the aqueous phase, then moving the equilibrium to the left, by adding water, in order to recycle the solvent.

Nevertheless, when the mixture of heavy rare earth elements to be processed contains a significant proportion of lighter rare earth elements (Sm, Eu, Gd), given the lower quantities of “light” rare earth elements (La, Ce, Pr, Nd), the organic phase throughput requires their extraction becoming very high, which requires mixers/settlers of significant size and creates excessive investment costs. In effect, the organic phase throughput is tied to the quantity of rare earth elements to be extracted (the one that passes into the solvent). Now, with the use of Aliquat, the selectivity is in the order Sm>Eu>Gd . . . >Yb>Lu. In concentrates containing mostly Sm, Eu, Gd, the majority rare earth elements need to be extracted, which leads to an increased solvent throughput.

Current processes for separating mixtures rich in heavy rare earth elements require significant quantities of acids and bases for their operation, which generally leads to significant costs tied to the prices of reactants, and generates a consequent volume of saline effluents, which need to be recycled, or released into the environment. In fact, current separation processes each present their limits:
those that use a organophosphorus acid: increased consumption of acids and bases, in particular for the extraction of heavier rare earth elements;
those that use a quaternary ammonium: an increased solvent throughput, in particular for mixtures containing mostly Sm, Eu, Gd.

### SUMMARY OF THE INVENTION

The applicant has reported that by combining an extraction solvent comprising a quaternary ammonium compound and an extraction solvent comprising an organophosphorus acid compound in the process for separating rare earth elements, it was possible to preserve the advantages tied to each one of these molecules by very strongly limiting the associated drawbacks.

Therefore, the present invention is related to a process for the production of a terbium-dysprosium mixture or dysprosium from a mixture of rare earth elements in solution comprising at least two consecutive steps for separation by liquid-liquid extraction, conducted with the use of two different solvents, making it possible to limit the consumption of bases and acids tied to the operation of the process and to generate fewer saline effluents.

The invention concerns a process for the production of a terbium-dysprosium mixture or of dysprosium from a mixture of rare earth elements in solution, said process comprising at least two consecutive steps of separation by liquid-liquid extraction, conducted with the use of two different solvents, S1 and S2:
the first separation step being conducted with the use of solvent S1, which comprises at least one anionic extraction agent,
the second separation step being conducted with the use of solvent S2, which comprises at least one cationic extraction agent.

The mixture of rare earth elements in solution preferably comprises a first group of rare earth elements HREE_{M}, comprising the elements Sm, Eu, Gd, Tb and Dy, and a second group of rare earth elements HREE_{H} comprising the elements Ho, Er, Tm, Yb, Lu and Y.

The first separation step preferentially separates the elements included in the HREE_{H} group of elements from the elements included in the HREE_{M} group.

The second separation step preferentially separates between those elements included in the HREE_{M} group in order to isolate the terbium-dysprosium mixture or the dysprosium.

The mixture of rare earth elements in solution can be a solution coming from ores rich in heavy rare earth elements, preferably xenotime or ionic clays.

According to one embodiment, the mixture of rare earth elements in solution is a mixture of rare earth element nitrates in solution.

The mixture of rare earth elements in solution can comprise at least 50 mol % of HREE_{H}, preferably at least 70 mol % of HREE_{H}.

According to one embodiment, the mixture of rare earth elements in solution undergoes a first separation step using solvent S1, generating a fraction comprising the elements included in the HREE_{M} group, said fraction subsequently undergoing a second separation step using solvent S2, with one of the products of said second separation being a terbium-dysprosium mixture or dysprosium.

According to another embodiment, the mixture of rare earth elements in solution undergoes a first separation step using the solvent S1, generating a fraction comprising the elements included in the HREE_{M} group, said fraction next being mixed with a solution pre-enriched with heavy rare earth elements coming from ores rich in light rare earth elements, preferably monazite or bastnaesite, said fraction undergoing a second separation step using solvent S2.

The ores, such as monazite or bastnaesite, include mainly the so-called “light” rare earth elements. A liquid-liquid extraction step can be done first to separate the “light” rare earth elements from the heavy rare earth elements. The mixture of heavy rare earth elements obtained in this way can then undergo the procedure that is the object of the present invention.

Ores including mainly heavy rare earth elements, such as xenotime or ionic clays, can undergo a first separation between the “light” rare earth elements and the heavy ones.

The solution pre-enriched with heavy rare earth elements coming from ores rich in light rare earth elements preferably comprises at least 80 mol % of heavy rare earth elements, preferably at least 95 mol % of heavy rare earth elements, said heavy rare earth elements comprising at least 60 mol % of elements included in the HREE_{M} group, preferably at least 80 mol % of elements included in the HREE_{M} group.

In this embodiment, the product of the second separation step, containing terbium and dysprosium, undergoes a third separation step with the use of the solvent S2, generating a terbium-dysprosium mixture or dysprosium.

As a variant, the separation steps are conducted using mixer/settler batteries or liquid-liquid extraction columns.

Advantageously, the anionic extraction agent is methyltrialkylammonium nitrate. For example, the anionic extraction agent can be methyltrioctylammonium nitrate.

The cationic extraction agent is preferably chosen from the group composed of alkylphosphonic derivatives, alkylphosphinic derivatives and their mixtures, such as the mono-2-ethylhexyl ester of 2-ethylhexylphosphonic acid (HEH (EH) P), trihexyltetradecylphosphonium bis(2,4,4-trimethylpentyl)phosphinate (known under its commercial name of CYANEX®272), a mixture of phosphonic acid and phosphinic acid (known under its commercial name of CYANEX®572).

The extraction agents have a concentration in the solvents that make it possible to preserve a viscosity of less than 20 cP, preferably a concentration between 0.1 and 2 mol/L, preferentially between 0.5 and 1.5 mol/L, for the organophosphorus acids, and between 0.1 and 0.8 mol/L, and preferably between 0.3 and 0.6 mol/L, for the quaternary ammoniums.

Solvents S1 and S2 may additionally comprise aliphatic or aromatic hydrocarbons with 5 to 16 carbon atoms, and optionally at least one modifier chosen from among the fatty alcohols.

The aliphatic or aromatic hydrocarbons can be diluents that allow solubilization of the extraction agents, and that do not modify their chemical properties.

We can cite as aliphatic or aromatic hydrocarbons: hexane, heptane, kerosene, toluene, benzene, Solvesso™ 150 (an aromatic hydrocarbon), ketones and alcohols.

The invention can be realized in a battery of multi-step liquid-liquid mixers/settlers, or in multi-step liquid-liquid extraction column, preferably with counter-current operation.

The process of the invention is preferably realized at a temperature between 20° C. and 90° C. This temperature is preferentially below the flash point of the mixture.

The process according to the invention makes it possible to reduce the quantities of bases and acids used in the process.

### BRIEF DESCRIPTION OF THE DRAWINGS

The manner by which the invention can be realized, and the advantages that arise from it, will be better highlighted by the following exemplary embodiments, which are illustrative and not limiting, with the help of the attached drawings.

FIG. 1 is a schematic representation of the process according to the invention corresponding to Example 1, in two liquid-liquid extraction batteries.

FIG. 2 is a schematic representation of the process corresponding to Comparative Example 1, in two liquid-liquid extraction batteries.

FIG. 3 is a schematic representation of the process according to the invention corresponding to Example 2, in two liquid-liquid extraction batteries.

FIG. 4 is a schematic representation of the process according to the invention corresponding to Comparative Example 2, in two liquid-liquid extraction batteries.

FIG. 5 is a schematic representation of the process according to the invention corresponding to Example 3, in three liquid-liquid extraction batteries.

FIG. 6 is a schematic representation of the process according to the invention corresponding to Comparative Example 3, in two liquid-liquid extraction batteries.

### DESCRIPTION OF THE INVENTION

The examples below were simulated with the use of software, in this case called “PAREX+”, developed by the applicant, in which the base data needed for the calculations were obtained beforehand by laboratory tests according to the different chemical systems presented.

The liquid-liquid extraction batteries were fed by two types of solutions:
one solution of heavy rare earth elements coming from a xenotime type raw material;
a first solution of heavy rare earth elements coming from a bastnaesite-type ore and a second solution of heavy rare earth elements coming from an ionic clay-type ore.

### Example 1: Process According to the Invention for Production of Dy from a Solution of a Mixture of Heavy Rare Earth Element Nitrates, Coming from a Xenotime-Type Ore

The process for Example 1, implementing the invention, is realized with the use of the following device:
a first mixer/settler type liquid-liquid extraction battery in counter-current operation, consisting of a 48-step extraction section (32), a 33-step washing section (33) and a 6-step extraction section (34), these three sections being connected to each other,
a second mixer/settler type liquid-liquid extraction battery in counter-current operation, consisting of a 13-step extraction section (35), a 14-step washing section (36) and a 6-step extraction section (37), these three sections being connected to each other.

The first extraction section is fed with an aqueous solution constituted by a mixture of heavy rare earth element nitrates (Sm, Eu, Gd, Tb, Dy, Ho, Er, Tm, Yb, Lu and Y), with a throughput of 240 L/hr (1), the composition of which is detailed in Tables 1 and 2.

The solution is extracted in the extraction section (2).

The solvent S1, composed of 30% Aliquat™ 336 in a nitrate form, and 70% Solvesso™ 150 by volume, is injected with a throughput of 6500 L/hr (3). Here, Aliquat™ 336 is the anionic extraction agent. This product is sold in its chloride form. For the invention, it processed beforehand in order to transform it into its nitrate form.

An aqueous raffinate mostly comprising the rare earth elements Ho, Er, Tm, Yb, Lu and Y is obtained (4).

A portion of the raffinate is re-injected into the extraction section with a throughput of 385 L/hr (5), after concentration, in order to conduct the loading of the solvent.

Around 576 L/hr of water are evaporated (30).

An aqueous extract comprising mostly the rare earth elements Sm, Eu, Gd, Tb and Dy is obtained and fed into the second extraction battery with a throughput of 54 L/hr (6).

The solvent undergoes washing before being introduced into re-extraction by injecting either a portion of the extract or a portion of the water into the washing section, with a throughput of 608 L/hr (7).

Around 317 L/hr of water coming from the extract are evaporated (31).

The extraction section of the second battery is fed with an aqueous ammonia solution with an HO⁻ concentration of 4 mol/L, with a throughput of 120 L/hr (8).

An aqueous nitric acid solution with an H⁺ concentration of 3.2 mol/L is fed into the re-extraction section with a throughput of 198 L/hr (8).

Solvent S2 is fed into the second battery with a throughput of 1200 L/hr (10). Solvent S2 is composed of 67% kerosene and 33% HEH (EH) P, by volume. Here, HEH (EH) P is the cationic extraction agent.

An aqueous raffinate composed mostly of Sm, Eu, Gd and Tb is obtained (11).

An extract comprising 90.83 g/L of Dy is recovered (12). The extract then undergoes another wash by being re-injected into the washing section with a throughput of 114 L/hr (13), this washing being done by either a portion of the extract, or by an acid solution.

Aqueous effluents are recovered at the output of the second battery section (14). They essentially contain ammonium nitrate, and can be developed, for example, into fertilizers.

The process according to the invention uses two solvents S1 and S2 consecutively.

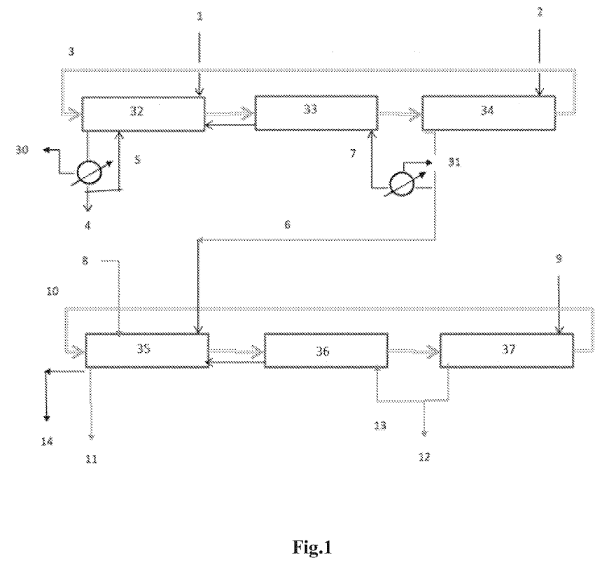

The summary diagram of the process from Example 1 according to the invention is reported in FIG. 1. The quantities of rare earth elements and the throughputs are reported in Tables 1 and 2.

TABLE 1

| | 1 | 2 | 3 | 4 | 5 | 30 | 6 | 7 | 31 |
|---|---|---|---|---|---|---|---|---|---|
| Nature | Aqueous | Aqueous | Organic | Aqueous | Aqueous | Aqueous | Aqueous | Aqueous | Aqueous |
| Throughput | 240 | 867 | 6500 | 153 | 385 | | 54 | 608 | |
| (L/hr) | | | | | | | | | |
| Sm (g/L) | 6.80 | | | <0.001 | | | 30.04 | 45.82 | |
| Eu (g/L) | 1.47 | | | <0.001 | | | 6.52 | 9.94 | |
| Gd (g/L) | 18.43 | | | <0.001 | | | 81.47 | 124.25 | |
| Tb (g/L) | 3.98 | | | <0.001 | | | 17.60 | 26.85 | |
| Dy (g/L) | 27.24 | | | 0.0024 | | | 120.41 | 183.65 | |
| Ho (g/L) | 5.83 | | | 9.17 | | | 0.03 | 0.05 | |
| Er (g/L) | 16.86 | | | 26.53 | | | <0.001 | <0.001 | |
| Tm (g/L) | 2.35 | | | 3.70 | | | <0.001 | <0.001 | |
| Yb (g/L) | 13.81 | | | 21.72 | | | <0.001 | <0.001 | |
| Lu (g/L) | 1.88 | | | 2.96 | | | <0.001 | <0.001 | |
| Y (g/L) | 162.77 | | | 256.07 | | | <0.001 | <0.001 | |
| OH⁻ | | | | | | | | | |
| (mol/L) | | | | | | | | | |
| H⁺ | 0.1 | 0.1 | | 0.01 | | | 0.01 | 0.01 | |
| (mol/L) | | | | | | | | | |
| Aliquat 336 | | | 30 | | | | | | |
| (% vol) | | | | | | | | | |
| Solvesso | | | 70 | | | | | | |
| 150 | | | | | | | | | |
| (% vol) | | | | | | | | | |
| HEH(EH)P | | | | | | | | | |
| (% vol) | | | | | | | | | |
| kerosene | | | | | | | | | |
| (% vol) | | | | | | | | | |

TABLE 2

| | 8 | 9 | 10 | 11 | 12 | 13 | 14 |
|---|---|---|---|---|---|---|---|
| Nature | Aqueous | Aqueous | Organic | Aqueous | Aqueous | Aqueous | Aqueous |
| Throughput | 120 | 198 | 1200 | 86 | 72 | 114 | 422 |
| (L/hr) | | | | | | | |
| Sm | | | | 19.10 | <0.001 | <0.001 | |
| (g/L) | | | | | | | |
| Eu | | | | 4.14 | <0.001 | <0.001 | |
| (g/L) | | | | | | | |
| Gd | | | | 51.82 | <0.001 | <0.001 | |
| (g/L) | | | | | | | |
| Tb | | | | 11.19 | 0.01 | 0.01 | |
| (g/L) | | | | | | | |
| Dy | | | | <0.001 | 90.83 | 90.83 | |
| (g/L) | | | | | | | |
| Ho | | | | | | | |
| (g/L) | | | | | | | |
| Er | | | | | | | |
| (g/L) | | | | | | | |
| Tm | | | | | | | |
| (g/L) | | | | | | | |
| Yb | | | | | | | |
| (g/L) | | | | | | | |
| Lu | | | | | | | |
| (g/L) | | | | | | | |
| Y | | | | | | | |
| (g/L) | | | | | | | |
| OH⁻ | 4 | | | | | | |
| (mol/L) | | | | | | | |
| H⁺ | | 3.2 | | 0.084 | 1.734 | 1.734 | 0.060 |
| (mol/L) | | | | | | | |
| Aliquat 336 | | | | | | | |
| (% vol) | | | | | | | |
| Solvesso | | | | | | | |
| 150 | | | | | | | |
| (% vol) | | | | | | | |
| HEH(EH)P | | | 33 | | | | |
| (% vol) | | | | | | | |
| kerosene | | | 67 | | | | |
| (% vol) | | | | | | | |

### Comparative Example 1: Process for the Production of Dy from a Solution of a Mixture of Heavy Rare Earth Element Chlorides Coming from a Xenotime-Type Ore

This comparative example results from conventional industrial processes, which operate using the chloride pathway.

The process is performed using the following device:
a first mixer/settler type liquid-liquid extraction battery in counter-current operation, consisting of a 15-step extraction section (38), a 17-step washing section (39) and a 6-step re-extraction section (40), these three sections being connected to each other,
a second mixer/settler type liquid-liquid extraction battery in counter-current operation, consisting of a 12-step extraction section (41), a 12-step washing section (42) and a 6-step re-extraction section (43), these three sections being connected to each other.

The first extraction section is fed with an aqueous solution constituted by a mixture of heavy rare earth element chlorides, with a throughput of 427 L/hr (1), the composition of which is detailed in Tables 3 and 4.

An aqueous soda solution with an HO⁻ concentration of 8 mol/L is fed into the first battery with a throughput of 284 L/hr (2).

An aqueous hydrochloric acid solution with an H⁺ concentration of 5.5 mol/L is fed into the re-extraction section with a throughput of 482 L/hr (3).

Solvent S2 is fed into the first battery with a throughput of 5680 L/hr (4). Solvent S2 is composed of 67% kerosene and 33% HEH (EH) P, by volume. Here, HEH (EH) P is the cationic extraction agent.

An aqueous raffinate mostly comprising the rare earth elements Sm, Eu, Gd, Tb and Dy is obtained (5).

Aqueous effluents (around 719 L/hr) are recovered at the output of the first battery (8) and are released into the environment.

An aqueous extract mostly comprising the rare earth elements Ho, Er, Tm, Yb, Lu and Y is obtained and fed into the second extraction battery (6).

The solvent undergoes washing before being introduced into re-extraction by injecting a portion of the extract into the washing section, with a throughput of 136 L/hr (7).

The extraction section of the second battery is fed with an aqueous soda solution with an HO⁻ concentration of 8 mol/L, with a throughput of 50 L/hr (9).

An aqueous hydrochloric acid solution with an H⁺ concentration of 5 mol/L is fed into the re-extraction section with a throughput of 92 L/hr (10).

Solvent S2 is fed into the second battery with a throughput of 1000 L/hr (11).

An aqueous raffinate composed mostly of the elements Sm, Eu, Gd and Tb is obtained (12). An extract composed of 158.99 g/L of Dy is recovered (13). The solvent undergoes washing before being introduced into re-extraction by injecting a portion of the extract into the washing section, with a throughput of 57 L/hr (14).

Aqueous effluents containing only NaCl are recovered at the output of the second battery section (15) and are released into the environment.

This process only uses a single solvent, solvent S3.

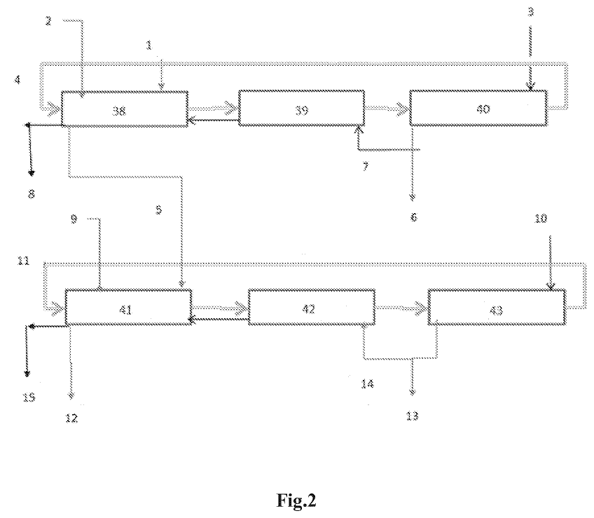

The summary diagram of the process from Comparative Example 1 is reported in FIG. 2. The quantities of rare earth elements and the throughputs are reported in Tables 3 and 4.

TABLE 3

| | 1 | 2 | 3 | 4 | 5 | 6 | 7 |
|---|---|---|---|---|---|---|---|
| Nature | Aqueous | Aqueous | Aqueous | Organic | Aqueous | Aqueous | Aqueous |
| Throughput | 427 | 284 | 482 | 5680 | 49 | 291 | 136 |
| (L/hr) | | | | | | | |
| Sm | 3.82 | | | | 26.22 | <0.001 | <0.001 |
| (g/L) | | | | | | | |
| Eu | 0.83 | | | | 5.69 | <0.001 | <0.001 |
| (g/L) | | | | | | | |
| Gd | 10.37 | | | | 71.11 | <0.001 | <0.001 |
| (g/L) | | | | | | | |
| Tb | 2.24 | | | | 15.37 | <0.001 | <0.001 |
| (g/L) | | | | | | | |
| Dy | 15.32 | | | | 105.05 | 0.01 | 0.01 |
| (g/L) | | | | | | | |
| Ho | 3.28 | | | | 0.03 | 4.10 | 4.10 |
| (g/L) | | | | | | | |
| Er | 9.49 | | | | <0.001 | 11.87 | 11.87 |
| (g/L) | | | | | | | |
| Tm | 1.32 | | | | <0.001 | 1.65 | 1.65 |
| (g/L) | | | | | | | |
| Yb | 7.77 | | | | <0.001 | 1.29 | 1.29 |
| (g/L) | | | | | | | |
| Lu | 1.06 | | | | <0.001 | 0.07 | 0.07 |
| (g/L) | | | | | | | |
| Y | 91.56 | | | | <0.001 | 114.60 | 114.60 |
| (g/L) | | | | | | | |
| OH⁻ | | 8 | | | | | |
| (mol/L) | | | | | | | |
| H⁺ | 0.1 | | 5.5 | | 0.23 | 1.29 | 1.29 |
| (mol/L) | | | | | | | |
| Aliquat 336 | | | | | | | |
| (% vol) | | | | | | | |
| Solvesso | | | | | | | |
| 150 | | | | | | | |
| (% vol) | | | | | | | |
| HEH(EH)P | | | | 33 | | | |
| (% vol) | | | | | | | |
| kerosene | | | | 67 | | | |
| (% vol) | | | | | | | |

TABLE 4

| | 8 | 9 | 10 | 11 | 12 | 13 | 14 | 15 |
|---|---|---|---|---|---|---|---|---|
| Nature | Aqueous | Aqueous | Aqueous | Organic | Aqueous | Aqueous | Aqueous | Aqueous |
| Throughput | 719 | 50 | 92 | 1000 | 28 | 35 | 57 | 135 |
| (L/hr) | | | | | | | | |
| Sm | | | | | 47.46 | <0.001 | <0.001 | |
| (g/L) | | | | | | | | |
| Eu | | | | | 10.19 | <0.001 | <0.001 | |
| (g/L) | | | | | | | | |
| Gd | | | | | 123.02 | <0.001 | <0.001 | |
| (g/L) | | | | | | | | |
| Tb | | | | | 26.32 | <0.001 | <0.001 | |
| (g/L) | | | | | | | | |
| Dy | | | | | <0.001 | 158.99 | 158.99 | |
| (g/L) | | | | | | | | |
| Ho | | | | | | | | |
| (g/L) | | | | | | | | |
| Er | | | | | | | | |
| (g/L) | | | | | | | | |
| Tm | | | | | | | | |
| (g/L) | | | | | | | | |
| Yb | | | | | | | | |
| (g/L) | | | | | | | | |
| Lu | | | | | | | | |
| (g/L) | | | | | | | | |
| Y | | | | | | | | |
| (g/L) | | | | | | | | |
| OH⁻ | | 8 | | | | | | |
| (mol/L) | | | | | | | | |
| H⁺ | 0.14 | | 5 | | 0.13 | 1.57 | 1.57 | 0.08 |
| (mol/L) | | | | | | | | |
| Aliquat 336 | | | | | | | | |
| (% vol) | | | | | | | | |
| Solvesso | | | | | | | | |
| 150 | | | | | | | | |
| (% vol) | | | | | | | | |
| HEH(EH)P | | | | 33 | | | | |
| (% vol) | | | | | | | | |
| kerosene | | | | 67 | | | | |
| (% vol) | | | | | | | | |

### Comparison of the Processes from Example 1 and Comparative Example 1 Vis-a-Vis the Consumption of Reactants and the Production of Saline Effluents

The process according to the invention makes it possible to divide the molar consumption of acids by 5 (10.0 moles of acid per kg of heavy rare earth elements versus 50.0 moles for the process that is not according to the invention) and to divide the molar consumption of bases by 6.9 (7.6 moles per kg of heavy rare earth elements versus 52.5 moles for the process that is not according to the invention).

In addition, the process according to the invention generates ammonium nitrate in a quantity very clearly less than the sodium chloride generated by the process that is not according to the invention (0.61 kg per kg of heavy rare earth elements, versus 3.07 kg for the process that is not according to the invention). The ammonium nitrate can be easily developed in the fertilizer industry. The NaCl is released into the environment.

Values are reported in Table 5.

TABLE 5
Xenotime Heavy REE (Dy purification)

| | | Consumption per kg of REE | | | | | | | | Effluents | |
|---|---|---|---|---|---|---|---|---|---|---|---|
| | REE | HCl 100% | | NaOH 100% | | HNO3 100% | | NH3 100% | | (kg/kg REE) | |
| | capacity | kg/kg | Mkg | kg/kg | Mkg | kg/kg | Mkg | kg/kg | Mkg | NaCl | NH4NO3 |
| Process | kg/hr | REE | REE | REE | REE | REE | REE | REE | REE | 100% | 100% |
| According | 628 | | | | | 0.64 | 10.1 | 0.13 | 7.6 | | 0.611 |
| to patent | | | | | | | | | | | |
| Conventional | 628 | 1.81 | 50 | 2.10 | 52.52 | | | | | 3.072 | |

### Example 2: Process According to the Invention for Production of a Mixture of Tb and Dy from a Solution of a Mixture of Heavy Rare Earth Element Nitrates Coming from a Xenotime-Type Ore

The process according to the invention is performed using the following device:
a first mixer/settler type liquid-liquid extraction battery in counter-current operation, consisting of a 48-step extraction section (44), a 33-step washing section (45) and a 6-step re-extraction section (46), these three sections being connected to each other,
a second mixer/settler type liquid-liquid extraction battery in counter-current operation, consisting of a 12-step extraction section (47), a 5-step washing section (48) and a 6-step re-extraction section (49), these three sections being connected to each other.

The first extraction section is fed with an aqueous solution constituted by a mixture of heavy rare earth element nitrates, with a throughput of 240 L/hr (1), the composition of which is detailed in Tables 6 and 7.

An aqueous acid solution with an H⁺ concentration of 0.1 mol/L is fed into the re-extraction section with a throughput of 867 L/hr (3).

Solvent S1, composed of 30% Aliquat™ 336, and 70% Solvesso™ 150 by volume, is injected with a throughput of 6500 L/hr (3). Here, the Aliquat™ 336 is the anionic extraction agent. This is transformed beforehand into a nitrate.

An aqueous raffinate mostly comprising the rare earth elements Ho, Er, Tm, Yb, Lu and Y is obtained (4).

A portion of the raffinate containing the unextracted rare earth elements is re-injected into the extraction section with a throughput of 385 L/hr (5).

Around 576 L/hr of water are evaporated (30).

An aqueous extract comprising mostly the rare earth elements Sm, Eu, Gd, Tb and Dy is obtained and fed into the second battery with a throughput of 54 L/hr (6).

The solvent undergoes washing before being introduced into re-extraction by injecting a portion of the extract into the washing section, with a throughput of 608 L/hr (7).

Around 317 L/hr of water coming from the extract are evaporated (31).

The extraction section of the second battery is fed with an aqueous ammonia solution with an HO⁻ concentration of 4 mol/L, with a throughput of 125 L/hr (8).

An aqueous solution of nitric acid with an H⁺ concentration of 3.2 mol/L is fed into the re-extraction section of the second battery with a throughput of 208 L/hr (9).

Solvent S2 is fed into the second battery with a throughput of 1250 L/hr (10). Solvent S2 is composed of 67% kerosene and 33% HEH (EH) P, by volume. Here, HEH (EH) P is the cationic extraction agent.

An aqueous raffinate composed mostly of Sm, Eu and Gd is obtained (11).

An extract comprising 11.43 g/L of Tb and 78.16 g/L of Dy is recovered (12). The solvent undergoes washing before being introduced into re-extraction by injecting a portion of the extract into the washing section, with a throughput of 111 L/hr (13).

Aqueous effluents are recovered at the output of the second battery section (14). They contain only ammonium nitrate, and can be developed into fertilizers.

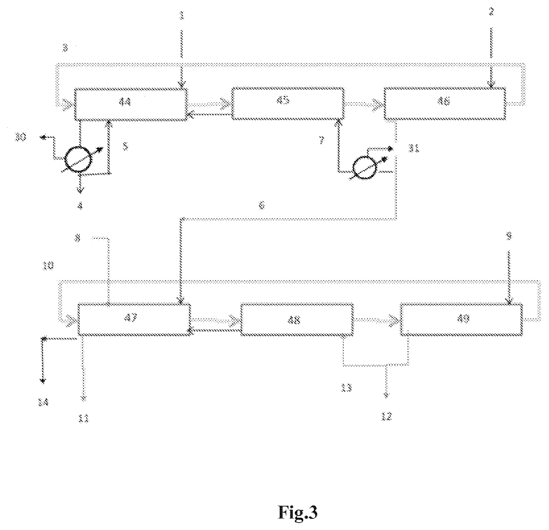

The summary diagram of the process from Example 2 is reported in FIG. 3. The quantities of rare earth elements and the throughputs are reported in Tables 6 and 7.

TABLE 6

| | 1 | 2 | 3 | 4 | 5 | 30 | 6 | 7 | 31 |
|---|---|---|---|---|---|---|---|---|---|
| Nature | Aqueous | Aqueous | Organic | Aqueous | Aqueous | Aqueous | Aqueous | Aqueous | Aqueous |
| Throughput | 240 | 867 | 6500 | 153 | 385 | | 54 | 608 | |
| (L/hr) | | | | | | | | | |
| Sm | 6.80 | | | <0.001 | | | 30.04 | 45.82 | |
| (g/L) | | | | | | | | | |
| Eu | 1.47 | | | <0.001 | | | 6.52 | 9.94 | |
| (g/L) | | | | | | | | | |
| Gd | 18.43 | | | <0.001 | | | 81.47 | 124.26 | |
| (g/L) | | | | | | | | | |
| Tb | 3.98 | | | <0.001 | | | 17.60 | 26.85 | |
| (g/L) | | | | | | | | | |
| Dy | 27.24 | | | 0.0024 | | | 120.41 | 183.65 | |
| (g/L) | | | | | | | | | |
| Ho | 5.83 | | | 9.17 | | | 0.03 | 0.05 | |
| (g/L) | | | | | | | | | |
| Er | 16.86 | | | 26.53 | | | <0.001 | <0.001 | |
| (g/L) | | | | | | | | | |
| Tm | 2.35 | | | 3.70 | | | <0.001 | <0.001 | |
| (g/L) | | | | | | | | | |
| Yb | 13.81 | | | 21.72 | | | <0.001 | <0.001 | |
| (g/L) | | | | | | | | | |
| Lu | 1.88 | | | 2.96 | | | <0.001 | <0.001 | |
| (g/L) | | | | | | | | | |
| Y | 162.77 | | | 256.07 | | | <0.001 | <0.001 | |
| (g/L) | | | | | | | | | |
| OH⁻ | | | | | | | | | |
| (mol/L) | | | | | | | | | |
| H⁺ | 0.1 | 0.1 | | 0.01 | | | 0.01 | 0.01 | |
| (mol/L) | | | | | | | | | |
| Aliquat 336 | | | 30 | | | | | | |
| (% vol) | | | | | | | | | |
| Solvesso | | | 70 | | | | | | |
| 150 | | | | | | | | | |
| (% vol) | | | | | | | | | |
| HEH(EH)P | | | | | | | | | |
| (% vol) | | | | | | | | | |
| kerosene | | | | | | | | | |
| (% vol) | | | | | | | | | |

TABLE 7

| | 8 | 9 | 10 | 11 | 12 | 13 | 14 |
|---|---|---|---|---|---|---|---|
| Nature | Aqueous | Aqueous | Organic | Aqueous | Aqueous | Aqueous | Aqueous |
| Throughput | 125 | 208 | 1250 | 74 | 84 | 111 | 434 |
| (L/hr) | | | | | | | |
| Sm | | | | 22.11 | <0.001 | <0.001 | |
| (g/L) | | | | | | | |
| Eu | | | | 4.80 | <0.001 | <0.001 | |
| (g/L) | | | | | | | |
| Gd | | | | 59.98 | <0.001 | <0.001 | |
| (g/L) | | | | | | | |
| Tb | | | | <0.001 | 11.43 | 11.43 | |
| (g/L) | | | | | | | |
| Dy | | | | <0.001 | 78.16 | 78.16 | |
| (g/L) | | | | | | | |
| Ho | | | | | | | |
| (g/L) | | | | | | | |
| Er | | | | | | | |
| (g/L) | | | | | | | |
| Tm | | | | | | | |
| (g/L) | | | | | | | |
| Yb | | | | | | | |
| (g/L) | | | | | | | |
| Lu | | | | | | | |
| (g/L) | | | | | | | |
| Y | | | | | | | |
| (g/L) | | | | | | | |
| OH⁻ | 4 | | | | | | |
| (mol/L) | | | | | | | |
| H⁺ | | 3.2 | | 0.07 | 1.75 | 1.75 | 0.05 |
| (mol/L) | | | | | | | |
| Aliquat 336 | | | | | | | |
| (% vol) | | | | | | | |
| Solvesso | | | | | | | |
| 150 | | | | | | | |
| (% vol) | | | | | | | |
| HEH(EH)P | | | 33 | | | | |
| (% vol) | | | | | | | |
| kerosene | | | 67 | | | | |
| (% vol) | | | | | | | |

### Comparative Example 2: Process for Production of a Mixture of Tb and Dy from a Solution of a Mixture of Heavy Rare Earth Element Chlorides Coming from a Xenotime-Type Ore

The process is performed using the following device:
a first mixer/settler type liquid-liquid extraction battery in counter-current operation, consisting of a 15-step extraction section (50), a 17-step washing section (51) and a 6-step re-extraction section (52), these three sections being connected to each other,
a second mixer/settler type liquid-liquid extraction battery in counter-current operation, consisting of a 10-step extraction section (53), a 4-step washing section (54) and a 6-step re-extraction section (55), these three sections being connected to each other.

The first extraction section is fed with a mixture of two aqueous solutions comprising a mixture of heavy rare earth element chlorides, with a throughput of 427 L/hr (1), the composition of which is detailed in Tables 8 and 9.

An aqueous soda solution with an HO⁻ concentration of 8 mol/L is fed into the first battery (2).

An aqueous hydrochloric acid solution with an H⁺ concentration of 5.5 mol/L is fed into the re-extraction section with a throughput of 482 L/hr (3).

Solvent S2 is fed into the first battery with a throughput of 5680 L/hr (4). Solvent S2 is composed of 67% kerosene and 33% HEH (EH) P, by volume. Here, HEH (EH) P is the cationic extraction agent.

An aqueous raffinate mostly comprising the rare earth elements Sm, Eu, Gd, Tb and Dy is obtained and fed into the second battery (5).

Aqueous effluents (around 719 L/hr) are recovered at the output of the first battery (8). They are made up of NaCl and are released into the environment.

An aqueous extract mostly comprising the rare earth elements Ho, Er, Tm, Yb, Lu and Y is obtained (6).

The solvent undergoes washing before being introduced into re-extraction by injecting a portion of the extract into the washing section, with a throughput of 136 L/hr (7).

The extraction section of the second battery is fed with an aqueous soda solution with an HO⁻ concentration of 8 mol/L, with a throughput of 63 L/hr (9).

An aqueous hydrochloric acid solution with an H⁺ concentration of 5 mol/L is fed into the re-extraction section with a throughput of 117 L/hr (10).

Solvent S2 is fed into the second battery with a throughput of 1250 L/hr (11).

An aqueous raffinate composed mostly of Sm, Eu and Gd is obtained (12).

An extract composed of process that is not according g/L of Tb and 149.58 g/L of Dy is recovered (13). The solvent undergoes washing before being introduced into re-extraction by injecting a portion of the extract into the washing section, with a throughput of 73 L/hr (14).

Aqueous effluents (around 169 L/hr) are recovered at the output of the second battery section (15). They only contain NaCl and are released into the environment.

This process only uses a single solvent, solvent S3.

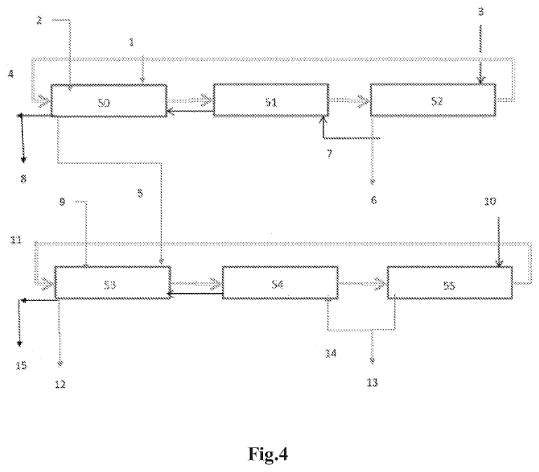

The summary diagram of the process from Comparative Example 2 is reported in FIG. 4. The quantities of rare earth elements and the throughputs are reported in Tables 8 and 9.

TABLE 8

| | 1 | 2 | 3 | 4 | 5 | 6 | 7 |
|---|---|---|---|---|---|---|---|
| Nature | Aqueous | Aqueous | Aqueous | Organic | Aqueous | Aqueous | Aqueous |
| Throughput | 427 | 284 | 482 | 5680 | 49 | 291 | 136 |
| (L/hr) | | | | | | | |
| Sm | 3.8 | | | | 26.2 | <0.001 | <0.001 |
| (g/L) | | | | | | | |
| Eu | 0.8 | | | | 5.7 | <0.001 | <0.001 |
| (g/L) | | | | | | | |
| Gd | 10.4 | | | | 71.1 | <0.001 | <0.001 |
| (g/L) | | | | | | | |
| Tb | 2.2 | | | | 15.4 | <0.001 | <0.001 |
| (g/L) | | | | | | | |
| Dy | 15.3 | | | | 105.1 | 0.01 | 0.01 |
| (g/L) | | | | | | | |
| Ho | 3.3 | | | | 0.03 | 4.1 | 4.1 |
| (g/L) | | | | | | | |
| Er | 9.5 | | | | <0.001 | 11.9 | 11.9 |
| (g/L) | | | | | | | |
| Tm | 1.3 | | | | <0.001 | 1.7 | 1.7 |
| (g/L) | | | | | | | |
| Yb | 7.8 | | | | <0.001 | 1.3 | 1.3 |
| (g/L) | | | | | | | |
| Lu | 1.1 | | | | <0.001 | 0.1 | 0.1 |
| (g/L) | | | | | | | |
| Y | 91.6 | | | | <0.001 | 114.6 | 114.6 |
| (g/L) | | | | | | | |
| OH⁻ | | 8 | | | | | |
| (mol/L) | | | | | | | |
| H⁺ | 0.1 | | 5.5 | | 0.23 | 1.29 | 1.29 |
| (mol/L) | | | | | | | |
| Aliquat 336 | | | | | | | |
| (% vol) | | | | | | | |
| Solvesso | | | | | | | |
| 150 | | | | | | | |
| (% vol) | | | | | | | |
| HEH(EH)P | | | | 33 | | | |
| (% vol) | | | | | | | |
| kerosene | | | | 67 | | | |
| (% vol) | | | | | | | |

TABLE 9

| | 8 | 9 | 10 | 11 | 12 | 13 | 14 | 15 |
|---|---|---|---|---|---|---|---|---|
| Nature | Aqueous | Aqueous | Aqueous | Organic | Aqueous | Aqueous | Aqueous | Aqueous |
| Throughput | 719 | 63 | 117 | 1250 | 25 | 44 | 73 | 169 |
| (L/hr) | | | | | | | | |
| Sm | | | | | 58.34 | <0.001 | <0.001 | |
| (g/L) | | | | | | | | |
| Eu | | | | | 12.66 | <0.001 | <0.001 | |
| (g/L) | | | | | | | | |
| Gd | | | | | 158.25 | <0.001 | <0.001 | |
| (g/L) | | | | | | | | |
| Tb | | | | | <0.001 | 21.869 | 21.869 | |
| (g/L) | | | | | | | | |
| Dy | | | | | <0.001 | 149.58 | 149.58 | |
| (g/L) | | | | | | | | |
| Ho | | | | | | | | |
| (g/L) | | | | | | | | |
| Er | | | | | | | | |
| (g/L) | | | | | | | | |
| Tm | | | | | | | | |
| (g/L) | | | | | | | | |
| Yb | | | | | | | | |
| (g/L) | | | | | | | | |
| Lu | | | | | | | | |
| (g/L) | | | | | | | | |
| Y | | | | | | | | |
| (g/L) | | | | | | | | |
| OH⁻ | | 8 | | | | | | |
| (mol/L) | | | | | | | | |
| H⁺ | 0.14 | | 5 | | 0.10 | 1.62 | 1.62 | 0.06 |
| (mol/L) | | | | | | | | |
| Aliquat 336 | | | | | | | | |
| (% vol) | | | | | | | | |
| Solvesso | | | | | | | | |
| 150 | | | | | | | | |
| (% vol) | | | | | | | | |
| HEH(EH)P | | | | 33 | | | | |
| (% vol) | | | | | | | | |
| kerosene | | | | 67 | | | | |
| (% vol) | | | | | | | | |

### Comparison of the Processes from Example 2 and Comparative Example 2 Vis-a-Vis the Consumption of Reactants and the Production of Saline Effluents

The invention's process makes it possible to divide the molar consumption of acids by 4.8 (10.6 moles of acid per kg of HREE versus 51.0 moles for the process that is not according to the invention) and to divide the molar consumption of bases by 5.5 (8.0 moles per kg of HREE versus 44.1 moles for the process that is not according to the invention).

In addition, the invention's process generates ammonium nitrate in a quantity very clearly less than the sodium chloride generated by the process that is not according to the invention (0.64 kg per kg of HREE, versus 2.58 kg for the process that is not according to the invention). This ammonium nitrate can be developed into fertilizers, while the sodium chloride is released into the environment.

Values are reported in Table 10.

TABLE 10
Xenotime Heavy REE (TbDy purification)

| | | Consumption per kg of REE | | | | | | | | | |
|---|---|---|---|---|---|---|---|---|---|---|---|
| | REE | HCl 100% | | NaOH 100% | | HNO3 100% | | NH3 100% | | Effluents (kg/kg REE) | |
| | capacity | kg/kg | Mkg | kg/kg | Mkg | kg/kg | Mkg | kg/kg | Mkg | NaCl | NH4NO3 |
| Process | kg/hr | REE | REE | REE | REE | REE | REE | REE | REE | 100% | 100% |
| According | 628 | | | | | 0.67 | 10.6 | 0.14 | 8.0 | | 0.637 |
| to patent | | | | | | | | | | | |
| Conventional | 628 | 1.88 | 51 | 1.76 | 44.11 | | | | | 2.580 | |

### Example 3: Process According to the Invention for Production of Dy from a First Solution of Heavy Rare Earth Element Nitrates Coming from a Bastnaesite-Type Ore and a Second Solution of Heavy Rare Earth Element Nitrates Coming from an Ionic Clay-Type Ore

The process is performed using the following device:
a first mixer/settler type liquid-liquid extraction battery in counter-current operation, consisting of a 25-step extraction section (56), a 28-step washing section (57) and a 6-step re-extraction section (58), these three sections being connected to each other,
a second mixer/settler type liquid-liquid extraction battery in counter-current operation, consisting of a 19-step extraction section (59), a 14-step washing section (60) and a 6-step re-extraction section (61), these three sections being connected to each other.
a third mixer/settler type liquid-liquid extraction battery in counter-current operation, consisting of an 18-step extraction section (62), a 16-step washing section (63) and a 6-step re-extraction section (64), these three sections being connected to each other.

The first extraction section is fed with an aqueous solution constituted by a mixture of heavy rare earth element nitrates coming from an ionic clay-type ore, with a throughput of 240 L/hr (1), the composition of which is detailed in Tables 11 and 12.

The solution is extracted in the re-extraction section (2).

The solvent S1, composed of 30% Aliquat™ 336, and 70% Solvesso™ 150 by volume, is injected with a throughput of 6100 L/hr (3). Aliquat™ 336 is the anionic extraction agent. It undergoes processing for its transformation into a nitrate form.

An aqueous raffinate mostly comprising the rare earth elements Ho, Er, Tm, Yb, Lu and Y is obtained (4).

An aqueous extract comprising mostly the rare earth elements Sm, Eu, Gd, Tb, Dy, Ho, Er and Y is obtained and fed into the second extraction battery with a throughput of 368 L/hr (5).

The solvent undergoes washing before being introduced into re-extraction by injecting a portion of the extract into the washing section, with a throughput of 330 L/hr (6).

Around 220 L/hr of water are evaporated (30).

The second battery is fed with a solution comprising a mixture of heavy rare earth elements coming from a bastnaesite-type ore (7), the composition of which is reported in Tables 11 and 12.

The extraction section of the second battery is fed with an aqueous ammonia solution with an HO⁻ concentration of 4 mol/L, with a throughput of 1227 L/hr (8).

An aqueous nitric acid solution with an H⁺ concentration of 3.5 mol/L is fed into the re-extraction section with a throughput of 5171 L/hr (9).

Solvent S2 is fed into the second battery with a throughput of 12270 L/hr (10). Solvent S2 is composed of 67% kerosene and 33% HEH (EH) P, by volume. Here, HEH (EH) P is the cationic extraction agent.

An aqueous raffinate composed mostly of Sm, Eu, Gd Tb and Dy is obtained (11).

An extract mostly composed of Ho, Er, Tm, Yb, Lu and Y is recovered (12). The solvent undergoes washing before being introduced into re-extraction by injecting a portion of the extract into the washing section with a throughput of 716 L/hr (13).

Aqueous effluents are recovered at the output of the second battery section (14). They are made up of ammonium nitrate, and can be developed into fertilizers.

An aqueous raffinate composed mostly of Sm, Eu, Gd, Tb and Dy is fed into the third battery.

An aqueous ammonia solution with an HO⁻ concentration of 4 mol/L is fed into the extraction section of the third battery with a throughput of 800 L/hr (15).

An aqueous nitric acid solution with an H⁺ concentration of 3.2 mol/L is fed into the re-extraction section with a throughput of 1268 L/hr (16).

Solvent S2 is fed into the third battery with a throughput of 8000 L/hr (17).

An aqueous raffinate composed mostly of Sm, Eu, Gd and Tb is obtained (18).

An extract comprising 89.40 g/L of Dy is recovered (19). The solvent undergoes washing before being introduced into re-extraction by injecting a portion of the extract into the washing section, with a throughput of 710 L/hr (20).

Aqueous effluents (2639 L/hr) are recovered at the output of the third battery (21). They are made up of ammonium nitrate, and can be developed into fertilizers.

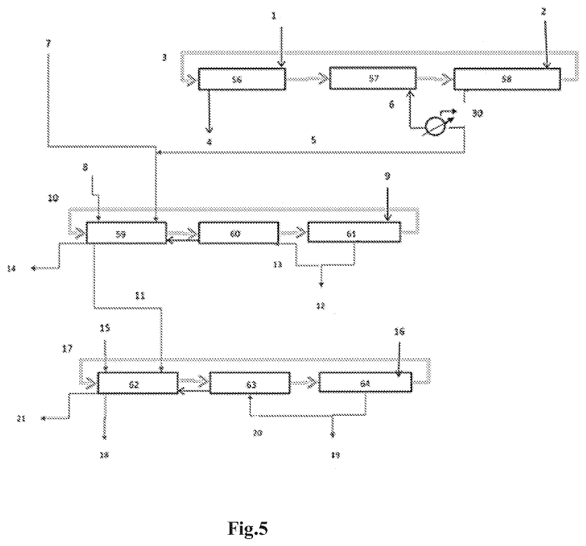

The summary diagram of the process from Example 3 according to the invention is reported in FIG. 5. The quantities of rare earth elements and the throughputs are reported in Tables 11 and 12.

TABLE 11

| | | | Re- | | | | | Water | | | Re- | | | |
|---|---|---|---|---|---|---|---|---|---|---|---|---|---|---|
| | | Feed | ex. | S1 | Raf. | Ext. | Wash | Evap. | Feed | HO⁻ | ex. | S2 | Raf. | Ext. |
| | | 1 | 2 | 3 | 4 | 5 | 6 | 30 | 7 | 8 | 9 | 10 | 11 | 12 |
| Nature | | Aq. | Aq. | Org. | Aq. | Aq. | Aq. | Aq. | Aq. | Aq. | Aq. | Org. | Aq. | Aq. |
| Throughput | | 778 | 813 | 6100 | 1002 | 368 | 330 | 220 | 3987 | 1227 | 5171 | 12270 | 2630 | 4834 |
| (L/hr) | | | | | | | | | | | | | | |
| Comp. | Sm | 32.48 | | | <0.001 | 68.70 | 114.69 | | 24.83 | | | | 36.55 | <0.001 |
| (g/L) | Eu | 1.98 | | | <0.001 | 4.18 | 6.98 | | 2.36 | | | | 3.47 | <0.001 |
| | Gd | 29.71 | | | <0.001 | 62.84 | 104.90 | | 20.28 | | | | 29.85 | <0.001 |
| | Tb | 4.85 | | | <0.001 | 10.25 | 17.11 | | 2.80 | | | | 4.11 | <0.001 |
| | Dy | 27.84 | | | <0.001 | 58.87 | 98.28 | | 12.55 | | | | 18.4718 | <0.001 |
| | Ho | 5.97 | | | 0.02 | 12.58 | 21.00 | | 2.11 | | | | <0.001 | 1.71 |
| | Er | 17.96 | | | 7.61 | 17.25 | 28.8153 | | 2.04 | | | | <0.001 | 2.50 |
| | Tm | 1.99 | | | 1.51 | 0.09 | 0.1533 | | 0.04 | | | | <0.001 | 0.04 |
| | Yb | 14.03 | | | 10.90 | <0.001 | <0.001 | | 0.52 | | | | <0.001 | 0.16 |
| | Lu | 2.01 | | | 1.56 | <0.001 | <0.001 | | 0.09 | | | | <0.001 | 0.02 |
| | Y | 204.91 | | | 156.79 | 6.28 | 10.4813 | | 17.27 | | | | <0.001 | 14.41 |
| HO⁻ | | | | | | | | | | 4 | | | | |
| (mol/L) | | | | | | | | | | | | | | |
| H⁺ | | 0.1 | 0.1 | | 0.01 | 0.01 | 0.01 | | 0.1 | | 3.5 | | | 0.1238 |
| (mol/L) | | | | | | | | | | | | | | |
| Aliquat | | | | 30 | | | | | | | | | | |
| 336 | | | | | | | | | | | | | | |
| (% vol) | | | | | | | | | | | | | | |
| Solvesso 150 | | | | 70 | | | | | | | | | | |
| (% vol) | | | | | | | | | | | | | | |
| HEH(EH)P | | | | | | | | | | | | 33 | | |
| (% vol) | | | | | | | | | | | | | | |
| Kerosene | | | | | | | | | | | | 67 | | |

TABLE 12

| | | Wash | Eff. | HO⁻ | Re-ex. | S2 | Raf. | Ext. | Wash | Eff. |
|---|---|---|---|---|---|---|---|---|---|---|
| | | 13 | 14 | 15 | 16 | 17 | 18 | 19 | 20 | 21 |
| Nature | | Aq. | Aq. | Aq. | Aq. | Org. | Aq. | Aq. | Aq. | Aq. |
| Throughput | | 716 | 543 | 800 | 1268 | 8000 | 2068 | 543 | 710 | 2639 |
| (L/hr) | | | | | | | | | | |
| Comp. | Sm | <0.001 | | | | | 46.44 | <0.001 | <0.001 | |
| (g/L) | Eu | <0.001 | | | | | 4.41 | <0.001 | <0.001 | |
| | Gd | <0.001 | | | | | 37.93 | <0.001 | <0.001 | |
| | Tb | <0.001 | | | | | 5.22 | <0.001 | <0.001 | |
| | Dy | <0.001 | | | | | <0.001 | 89.40 | 89.40 | |
| | Ho | 1.71 | | | | | | | | |
| | Er | 2.50 | | | | | | | | |
| | Tm | 0.04 | | | | | | | | |
| | Yb | 0.16 | | | | | | | | |
| | Lu | 0.02 | | | | | | | | |
| | L | 14.41 | | | | | | | | |
| HO⁻ | | | | 4 | | | | | | |
| (mol/L) | | | | | | | | | | |
| H⁺ | | 2.947 | 0.08 | | 3.2 | | 0.07464 | 1.561 | 1.561 | 0.058 |
| (mol/L) | | | | | | | | | | |
| Aliquat | | | | | | | | | | |
| 336 | | | | | | | | | | |
| (% vol) | | | | | | | | | | |
| Solvesso 150 | | | | | | | | | | |
| (% vol) | | | | | | | | | | |
| HEH(EH)P | | | | | | 33 | | | | |
| (% vol) | | | | | | | | | | |
| Kerosene | | | | | | 67 | | | | |

### Comparative Example 3: Process for Production of Dy from a Mixed Solution Comprising a Mixture of Heavy Rare Earth Element Chlorides Coming from a Bastnaesite-Type Ore and a Mixture of Heavy Rare Earth Element Chlorides Coming from an Ionic Clay-Type Ore

The process is performed using the following device:
a first mixer/settler type liquid-liquid extraction battery in counter-current operation, consisting of a 14-step extraction section (65), a 13-step washing section (66) and a 6-step re-extraction section (67), these three sections being connected to each other,
a second mixer/settler type liquid-liquid extraction battery in counter-current operation, consisting of a 12-step extraction section (68), an 8-step washing section (69) and a 6-step re-extraction section (70), these three sections being connected to each other.

The first extraction section is fed with a mixture of two aqueous solutions constituted by heavy rare earth element chlorides, one coming from a bastnaesite-type ore and the other coming from an ionic clay-type ore, with a throughput of 2480 L/hr (1), the composition of which is detailed in Tables 13 and 14.

An aqueous soda solution with an HO⁻ concentration of 8 mol/L is fed into the first battery with a throughput of 1825 L/hr (2).

An aqueous hydrochloric acid solution with an H⁺ concentration of 5.5 mol/L is fed into the re-extraction section with a throughput of 5188 L/hr (3).

Solvent S2 is fed into the first battery with a throughput of 36500 L/hr (4). Solvent S2 is composed of 67% kerosene and 33% HEH (EH) P, by volume. Here, HEH (EH) P is the cationic extraction agent.

An aqueous raffinate mostly comprising the rare earth elements Sm, Eu, Gd, Tb and Dy is obtained and fed into the second battery (5).

Aqueous effluents (5468 L/hr) are recovered at the output of the first battery (8). These effluents are composed of sodium chloride and are released into the environment.

An aqueous extract mostly comprising the rare earth elements Ho, Er, Tm, Yb, Lu and Y is obtained (6).

The solvent undergoes washing before being introduced into re-extraction by injecting a portion of the extract into the washing section with a throughput of 1165 L/hr (7).

The extraction section of the second battery is fed with an aqueous soda solution with an HO⁻ concentration of 8 mol/L, with a throughput of 400 L/hr (9).

An aqueous hydrochloric acid solution with an H⁺ concentration of 5 mol/L is fed into the re-extraction section with a throughput of 713 L/hr (10).

Solvent S2 is fed into the second battery with a throughput of 8000 L/hr (11).

An aqueous raffinate composed mostly of Sm, Eu, Gd and Tb is obtained (12).

An extract comprising 237.35 g/L of Dy is recovered (13). The solvent undergoes washing before being introduced into re-extraction by injecting a portion of the extract into the washing section, with a throughput of 404 L/hr (14).

Aqueous effluents (around 1172 L/hr) are recovered at the output of the second battery section (15). They are made up of sodium chloride and are released into the environment.

This process only uses a single solvent, solvent S3.

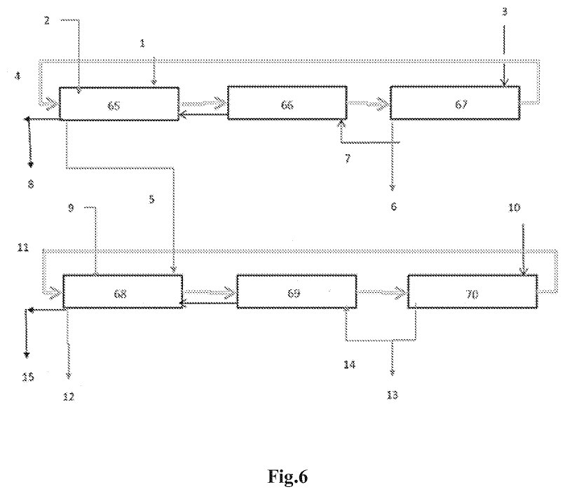

The summary diagram of the process from Comparative Example 3 is reported in FIG. 6. The quantities of rare earth elements and the throughputs are reported in Tables 13 and 14.

TABLE 13

| | 1 | 2 | 3 | 4 | 5 | 6 | 7 |
|---|---|---|---|---|---|---|---|
| Nature | Aqueous | Aqueous | Aqueous | Organic | Aqueous | Aqueous | Aqueous |
| Throughput | 2480 | 1825 | 5188 | 36500 | 1048 | 3591 | 1165 |
| (L/hr) | | | | | | | |
| Sm | 38.76 | | | | 91.75 | <0.001 | <0.001 |
| (g/L) | | | | | | | |
| Eu | 3.68 | | | | 8.71 | <0.001 | <0.001 |
| (g/L) | | | | | | | |
| Gd | 31.66 | | | | 74.95 | <0.001 | <0.001 |
| (g/L) | | | | | | | |
| Tb | 4.36 | | | | 10.31 | <0.001 | <0.001 |
| (g/L) | | | | | | | |
| Dy | 19.59 | | | | 46.39 | <0.001 | <0.001 |
| (g/L) | | | | | | | |
| Ho | 3.37 | | | | 0.001 | 2.32 | 2.32 |
| (g/L) | | | | | | | |
| Er | 8.22 | | | | <0.001 | 5.67 | 5.67 |
| (g/L) | | | | | | | |
| Tm | 0.68 | | | | <0.001 | 0.47 | 0.47 |
| (g/L) | | | | | | | |
| Yb | 5.21 | | | | <0.001 | 2.76 | 2.76 |
| (g/L) | | | | | | | |
| Lu | 0.77 | | | | <0.001 | 0.11 | 0.11 |
| (g/L) | | | | | | | |
| Y | 91.23 | | | | <0.001 | 63.01 | 63.01 |
| (g/L) | | | | | | | |
| OH⁻ | | 8 | | | | | |
| (mol/L) | | | | | | | |
| H⁺ | 0.1 | | 5.5 | | 0.19 | 3.67 | 3.67 |
| (mol/L) | | | | | | | |
| Aliquat 336 | | | | | | | |
| (% vol) | | | | | | | |
| Solvesso | | | | | | | |
| 150 | | | | | | | |
| (% vol) | | | | | | | |
| HEH(EH)P | | | | 33 | | | |
| (% vol) | | | | | | | |
| kerosene | | | | 67 | | | |
| (% vol) | | | | | | | |

TABLE 14

| | 8 | 9 | 10 | 11 | 12 | 13 | 14 | 15 |
|---|---|---|---|---|---|---|---|---|
| Nature | Aqueous | Aqueous | Aqueous | Organic | Aqueous | Aqueous | Aqueous | Aqueous |
| Throughput | 5468 | 400 | 713 | 8000 | 178 | 205 | 404 | 1172 |
| (L/hr) | | | | | | | | |
| Sm | | | | | 118.31 | <0.001 | <0.001 | |
| (g/L) | | | | | | | | |
| Eu | | | | | 11.24 | <0.001 | <0.001 | |
| (g/L) | | | | | | | | |
| Gd | | | | | 96.66 | <0.001 | <0.001 | |
| (g/L) | | | | | | | | |
| Tb | | | | | 13.31 | 0.003 | 0.003 | |
| (g/L) | | | | | | | | |
| Dy | | | | | <0.001 | 237.35 | 237.35 | |
| (g/L) | | | | | | | | |
| Ho | | | | | | | | |
| (g/L) | | | | | | | | |
| Er | | | | | | | | |
| (g/L) | | | | | | | | |
| Tm | | | | | | | | |
| (g/L) | | | | | | | | |
| Yb | | | | | | | | |
| (g/L) | | | | | | | | |
| Lu | | | | | | | | |
| (g/L) | | | | | | | | |
| Y | | | | | | | | |
| (g/L) | | | | | | | | |
| OH⁻ | | 8 | | | | | | |
| (mol/L) | | | | | | | | |
| H⁺ | 0.12 | | 5 | | 0.11 | 1.48 | 1.48 | 0.08 |
| (mol/L) | | | | | | | | |
| Aliquat 336 | | | | | | | | |
| (% vol) | | | | | | | | |
| Solvesso | | | | | | | | |
| 150 | | | | | | | | |
| (% vol) | | | | | | | | |
| HEH(EH)P | | | | 33 | | | | |
| (% vol) | | | | | | | | |
| kerosene | | | | 67 | | | | |
| (% vol) | | | | | | | | |

### Comparison of the Processes from Example 3 and Comparative Example 3 Vis-a-Vis the Consumption of Reactants and the Production of Saline Effluents

The process according to the invention makes it possible to reduce the molar consumption of acids by 30% (43.0 moles of acid per kg of heavy rare earth elements versus 62.0 moles for the process that is not according to the invention) and the molar consumption of bases by 54% (15.8 moles per kg of heavy rare earth elements versus 34.6 moles for the process that is not according to the invention).

In addition, the invention's process generates ammonium nitrate in a quantity very clearly less than the sodium chloride generated by the process that is not according to the invention (1.26 kg per kg of heavy rare earth elements, versus 2.02 kg for the process that is not according to the invention). Furthermore, the ammonium nitrate can be developed into fertilizers, while the sodium chloride is released into the environment.

Values are reported in Table 15.

TABLE 15
Heavy Rare Earth Elements (REE) (e.g. bastnaesite) + heavy REE (e.g. ionic clays)

| | | | | | | | | | | Effluents | |
|---|---|---|---|---|---|---|---|---|---|---|---|
| | | Consumption per kg of REE | | | | | | | | NaCl | NH₄NO₃ |
| | REE | HCl 100% | | NaOH 100% | | HNO₃ 100% | | NH₃ 100% | | 100% | 100% |
| | Capacity | kg/kg | M/kg | kg/kg | M/kg | kg/kg | M/kg | kg/kg | M/kg | kg/kg | kg/kg |
| | (kg/hr) | of REE | of REE | of REE | of REE | of REE | of REE | of REE | of REE | of REE | of REE |
| Process | 514.7 | | | | | 2.71 | 43.0 | 0.27 | 15.8 | | 1.261 |
| according to | | | | | | | | | | | |
| invention | | | | | | | | | | | |
| Conventional | 514.7 | 2.28 | 62 | 1.38 | 34.58 | | | | | 2.023 | |
| process | | | | | | | | | | | |

Table 16 summarizes the different examples detailed above.

TABLE 16

| | | | | Molar % of heavy rare |
|---|---|---|---|---|
| Example | Product obtained | Raw material 1 | Raw material 2 | earth elements |
| Example 1 | Dy | Xenotime | — | 81.9% |
| (invention) | | | | |
| Comparison 1 | Dy | Xenotime | — | 81.9% |
| (C1) | | | | |
| Example 2 | Tb and Dy | Xenotime | — | 81.9% |
| (invention) | | | | |
| Comparison 2 | Tb and Dy | Xenotime | — | 81.9% |
| (C2) | | | | |
| Example 3 | Dy | Bastnaesite | Ionic clay | 63.0% |
| (invention) | | | | |
| Comparison 3 | Dy | Mixed bastnaesite and ionic clay | | 63.0% |
| (C3) | | | | |

1. A process for the production of a terbium-dysprosium mixture or dysprosium from a mixture of rare earth elements in solution, said process comprising at least two consecutive steps for separation by liquid-liquid extraction, conducted with the use of two different solvents, S1 and S2:
the first separation step being conducted with the use of solvent S1, which comprises at least one anionic extraction agent,
the second separation step being conducted with the use of solvent S2, which comprises at least one cationic extraction agent.

2. The process for the production of a terbium-dysprosium mixture or dysprosium according to claim 1, wherein the mixture of rare earth elements in solution comprises a first group of rare earth elements HREE_{M}, comprising the elements Sm, Eu, Gd, Tb and Dy, and a second group of rare earth elements HREE_{H} comprising the elements Ho, Er, Tm, Yb, Lu and Y.

3. The process for the production of a mixture of terbium-dysprosium or dysprosium according to claim 2, wherein the first separation step separates the elements comprised in the HREE_{H} group from the elements comprised in the HREE_{M} group.

4. The process for the production of a mixture of terbium-dysprosium or dysprosium according to claim 2, wherein the second separation step separates the elements comprised in the HREE_{M} group from each other, to isolate the terbium-dysprosium mixture or the dysprosium.

5. The process for the production of a mixture of terbium-dysprosium or dysprosium according to claim 1, wherein the mixture of rare earth elements in solution is a solution coming from ores rich in heavy rare earth elements, preferably xenotime or ionic clays.

6. The process for the production of a mixture of terbium-dysprosium or dysprosium according to claim 2, wherein the mixture of rare earth elements in solution comprises at least 50 mol % of HREE_{H}, preferably at least 70 mol % of HREE_{H}.

7. The process for the production of a mixture of terbium-dysprosium or dysprosium, according to claim 2, wherein the mixture of rare earth elements in solution undergoes a first separation step using solvent S1, generating a fraction comprising the elements comprised in the HREE_{M} group, said fraction subsequently undergoing a second separation step using solvent S2, with the product of said second separation being a terbium-dysprosium mixture or dysprosium.

8. The process for the production of a mixture of terbium-dysprosium or dysprosium, according to claim 2, wherein the mixture of rare earth elements in solution undergoes a first separation step using solvent S1, generating a fraction comprising the elements comprised in the HREE_{M} group, said fraction next being mixed with a solution pre-enriched with heavy rare earth elements coming from ores rich in light rare earth elements, preferably monazite or bastnaesite, said fraction undergoing a second separation step using solvent S2.

9. The process for the production of a mixture of terbium-dysprosium or dysprosium, according to claim 8, wherein which the product of the second separation step containing terbium and dysprosium undergoes a third separation step using solvent S2, generating a terbium-dysprosium mixture or dysprosium.

10. The process for the production of a mixture of terbium-dysprosium or dysprosium, according to claim 1, wherein said separation steps are conducted by means of mixer/settler batteries or liquid-liquid extraction columns.

11. The process for the production of a mixture of terbium-dysprosium or dysprosium, according to claim 1, wherein the anionic extraction agent is methyltrialkylammonium nitrate.

12. The process for the production of a mixture of terbium-dysprosium or dysprosium, according to claim 1, wherein the cationic extraction agent is chosen from the group composed of alkylphosphonic derivatives, alkylphosphinic derivatives and their mixtures.

13. The process for the production of a mixture of terbium-dysprosium or dysprosium, according to claim 1, wherein the mixture of rare earth elements in solution is a mixture of rare earth element nitrates in solution.

14. The process for the production of a mixture of terbium-dysprosium or dysprosium, according to claim 1, wherein the solvents S1 and S2 comprise aliphatic or aromatic hydrocarbons with 5 to 16 atoms of carbon.

15. The process for the production of a mixture of terbium-dysprosium or dysprosium according to claim 14, wherein the solvents S1 and S2 comprise at least one modifier selected from fatty alcohols.
